(19) United States
(12) Patent Application Publication
(10) Pub. No.: US 2020/0393558 A1
(43) Pub. Date: Dec. 17, 2020

(54) SYSTEM AND METHOD OF ENHANCING A PERFORMANCE OF AN ELECTROMAGNETIC SENSOR

(71) Applicant: WISENSE TECHNOLOGIES LTD., Tel Aviv (IL)

(72) Inventors: Itai ORR, Or Akiva (IL); Moshik Moshe Cohen, Neve Savion (IL)

(73) Assignee: WISENSE TECHNOLOGIES LTD., Tel Aviv (IL)

(21) Appl. No.: 16/439,742

(22) Filed: Jun. 13, 2019

(51) Int. Cl. G01S 13/89; G06N 20/00; G06N 3/02

(52) U.S. Cl. CPC G01S 13/89; G06N 3/02; G06N 20/00

(57) ABSTRACT

A system and a method for training a machine learning (ML) model to enhance a performance of an electromagnetic (EM) sensor, the method including: receiving one or more first data elements pertaining to a first signal of an EM sensor having a first performance parameter value; receiving one or more second data elements pertaining to a second signal of a data generator having a second performance parameter value; and training the ML model to generate a third signal, using the one or more first data elements as a training data set and using the one or more second data elements as supervisory data, where the third signal is characterized by a third performance parameter value that is higher than the first performance parameter value.

### FIELD OF THE INVENTION

The present invention relates generally to systems of spatial imaging More specifically, the present invention relates to systems and methods for enhancing a performance of an electromagnetic sensor.

### BACKGROUND OF THE INVENTION

As known in the art, existing methods of enhancing performance of spatial imaging systems based on electromagnetic (EM) sensors such as radars are commonplace. Such methods normally utilize information that may be acquired by different platforms or modalities, use different formats and/or be sampled or acquired at different timeframes to generate spatial images (such as point clouds, range-Doppler maps or depth maps) that may present a performance that may surpass the inherent performance of the original imaging system.

For example, Synthetic Aperture Radar (SAR) systems may utilize information that may be repeatedly gathered over a relatively long period of time (e.g., longer than the time it would take to form a single radar image) to emulate a radar sensor that has a wide physical aperture, and thus produce a radar image that may have superior spatial resolution in relation to the radar's inherent resolution.

In another example, multi-modal images may be combined to provide comprehensive information of the image content and improve image analysis and processing, including for example: geometric corrections, segmentation, feature extraction, classification, registration, and detection performances.

### SUMMARY OF THE INVENTION

State of the art systems and methods for enhancing performance of spatial imaging systems (e.g., radars) do not provide an inherent, continuous enhancement to the function or performance of the spatial imaging system (e.g., the radar) itself. Instead, obtaining continuous, superior performance may depend upon continuous inflow of additional data (e.g., over time, or from different modalities).

State of the art systems do not learn the inherent weaknesses or disadvantages of the respective spatial imaging systems (e.g., radars), and may therefore not facilitate superior performance for single spatial images or when the spatial imaging systems are set or deployed alone.

Embodiments of the present invention may provide an improvement over state of the art systems and methods by training one or more machine learning (ML) modules to enhance the performance of a spatial imaging system, based on an EM sensor (e.g., a radar), so as to exhibit superior performance in relation to the spatial imaging system's original, inherent performance.

The term performance may be used herein in relation to an EM sensor (e.g., a radar) to refer to any metric or measurement that may be characteristic of the EM sensor, including for example: a spatial resolution, a temporal resolution, a frequency resolution, a Doppler resolution, a signal-to-noise ratio (SNR) and the like.

Embodiments of the present invention may include a method for training one or more ML models to enhance a performance of an EM sensor. Embodiments of the method may include:

receiving one or more first data elements pertaining to a first signal of an EM sensor having a first performance parameter value;

receiving one or more second data elements pertaining to a second signal of a data generator having a second performance parameter value; and

training the one or more ML models to generate a third signal, using the one or more first data elements as a training data set and using the one or more second data elements as supervisory data, where the third signal may be characterized by a third performance parameter value that may be higher than or superior to the first performance parameter value.

The performance parameter may be, for example: a spatial resolution, a temporal resolution, a frequency resolution, a Doppler resolution, an angular resolution, a signal-to-noise ratio (SNR) and the like.

The one or more second data elements may be, for example: a point cloud, generated by the data generator, a depth map generated by the data generator and/or a range-Doppler map generated by the data generator.

Embodiments of the present invention may include:

synchronizing between a first timing of the reception of the one or more first data elements and a second timing of the reception of the one or more second data elements; and

performing spatial registration between the one or more first data elements and the one or more second data elements.

According to some embodiments of the present invention, the one or more ML models may be self-supervised by the one or more second data elements.

The EM sensor may be a first radar and the data generator may be, for example: the first radar, a second radar, a light detection and ranging (LIDAR) sensor, an assembly of one or more cameras, and the like.

Additionally, or alternatively, the data generator may be a simulator module, configured to produce a simulated, three-dimensional environment, and the one or more second data elements may pertain to the simulated, three-dimensional environment.

Embodiments of the present invention may include constructing a radar image that may have or may be characterized by the third performance parameter value, based on the one or more third data elements.

Embodiments of the present invention may include a method of enhancing an EM sensor signal. Embodiments of the method may include:

receiving one or more data elements pertaining to a first signal of the EM sensor, the signal characterized by a first performance parameter value;

inputting the one or more data elements to a neural network (NN) model; and

generating a second signal from at least one output of the NN model, where the second signal may be characterized by a second performance parameter value, and wherein the second performance parameter value may be higher than or superior to the first performance parameter value.

Embodiments of the present invention may include a system for enhancing a signal of an EM sensor. Embodiments of the system may include a NN model, associated with the EM sensor and configured to receive one or more first data elements from the EM sensor, and produce therefrom one or more second data elements. The one or more first data elements may be characterized by a first performance parameter value and the one or more second data elements may be characterized by a second, higher performance parameter value.

Embodiments of the system may include:

a non-transitory memory device, wherein modules of instruction code may be stored; and

a processor associated with the memory device, and configured to execute the modules of instruction code, whereupon execution of the modules of instruction code, the processor may be configured to generate an image from the one or more second data elements, wherein the image may be characterized by the second performance parameter value.

Embodiments of the present invention may include a system for training one or more ML models to enhance a performance of an EM sensor. Embodiments of the system may include: a non-transitory memory device, wherein modules of instruction code may be stored, and a processor associated with the memory device, and configured to execute the modules of instruction code. Upon execution of the modules of instruction code, the processor may be configured to perform at least one of:

receive one or more first data elements pertaining to a first signal of the EM sensor having a first performance parameter value;

receive one or more second data elements pertaining to a second signal of a data generator, having a second performance parameter value; and

train at least one ML model to generate a third signal, using the one or more first data elements as a training data set and using the one or more second data elements as supervisory annotated data. The third signal may have or may be characterized by a third performance parameter value that may be higher than or superior to the first performance parameter value.

Embodiments of the system may include at least one digital signal processing module, having one or more processing modules, and where training at least one ML model to generate the third signal may include using one or more output data elements of one or more processing modules as a training data set.

The one or more ML models may be arranged in a cascade, where training at least one ML model to generate the third signal may include using an output of a preceding ML model (e.g., in the cascade) as supervisory annotated data.

According to some embodiments of the invention, the processor may be configured to:

synchronize between a first timing of the reception of the one or more first data elements and a second timing of the reception of the one or more second data elements;

perform spatial registration between the one or more first data elements and the one or more second data elements; and

use the one or more second data elements to self-supervise training of the one or more ML models.

Embodiments of the present invention may include a method for training an ML model to enhance a performance of an EM sensor. Embodiments of the method may include:

receiving one or more first data elements pertaining to a first signal of an EM sensor having a first performance parameter value;

generating one or more second data elements from the one or more first data elements having a second performance parameter value that may be lower than the first performance parameter value; and

training the ML model to generate a third signal, using the one or more second data elements as a training data set and using the one or more first data elements serve as supervisory data. The third signal may be characterized by a third performance parameter value that may be higher than or superior to the second performance parameter value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for enhancing a signal of an electromagnetic (EM) sensor, according to some embodiments; and

FIG. 2A is a block diagram, depicting a system for enhancing a signal of an EM sensor during a training stage, according to some embodiments;

FIG. 2B is a simplified block diagram, depicting a system for enhancing a signal of an EM sensor during a training stage, according to some embodiments;

FIG. 2C is a block diagram, depicting a system for enhancing a signal of an EM sensor during a training stage, according to some embodiments;

FIG. 2D is a block diagram depicting a system for enhancing a signal of an EM sensor, according to some embodiments;

FIG. 3 is a block diagram, depicting a system for enhancing a signal of an EM sensor during an operational stage, according to some embodiments; and

FIG. 4 is a flow diagram, depicting a method of training a machine learning model to enhance a performance of an EM sensor, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may include a method and a system for enhancing performance and/or image formation of an EM sensor (e.g., a radar).

The system may include for example:

an EM sensor (e.g., a first radar), having or characterized by a first value of performance parameter (e.g., a first spatial resolution, a first temporal resolution, a first frequency resolution, a first Doppler resolution, a first signal-to-noise ratio (SNR) and the like);

a data generator (e.g., a second radar, a LIDAR detector, an assembly of one or more cameras, etc.) having or being characterized by a second value of performance parameter (e.g., a second spatial resolution, a second temporal resolution, a second frequency resolution, a second Doppler resolution, a second SNR, etc.) that is superior to (e.g., higher than) the first value of performance parameter; and

at least one machine learning (ML) module that may be or may include one or more neural network (NN) models.

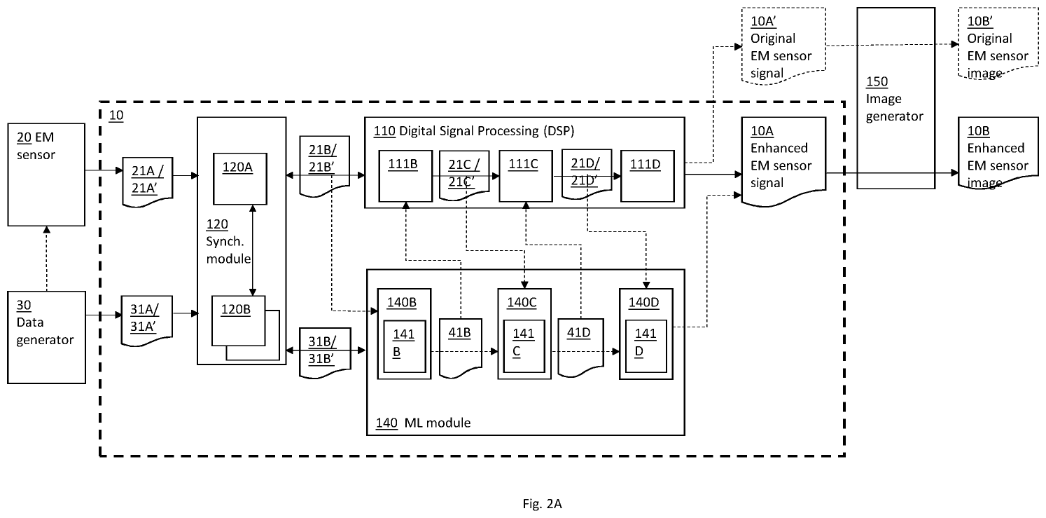

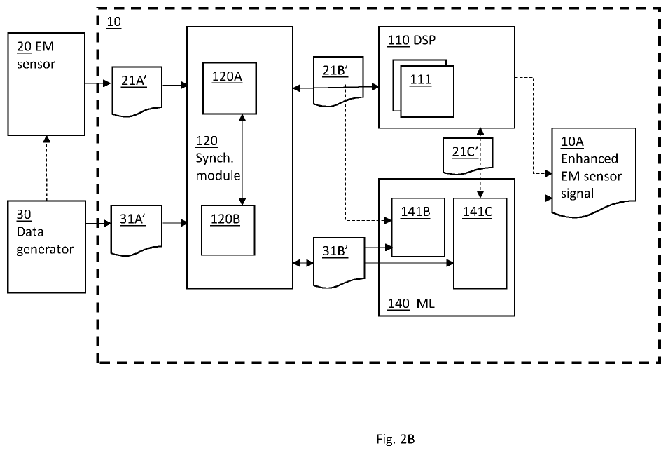

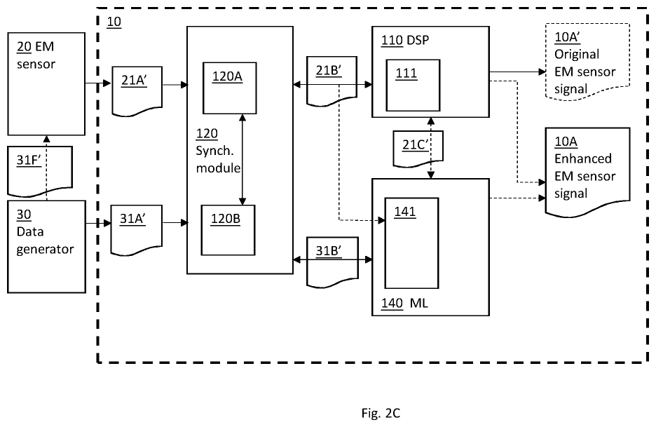

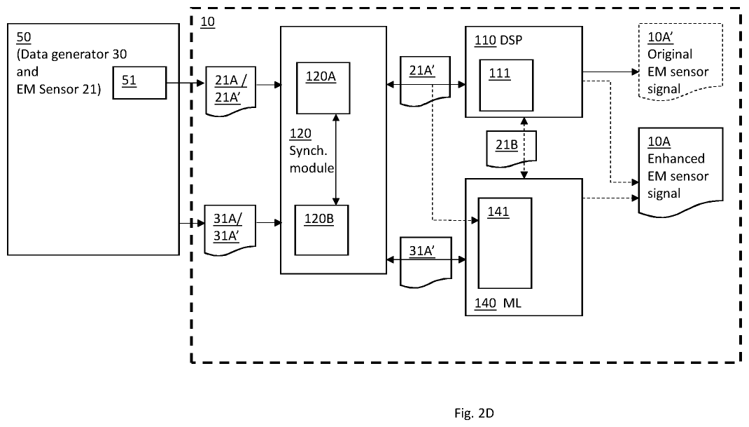

According to some embodiments, as elaborated herein in relation to FIG. 2D, the data generator may be implemented as the same entity as the EM sensor. For example, the EM sensor and the data generator may both be implemented as the same element, such as the same radar.

The at least one ML module may be trained on a first signal (e.g., a preprocessed signal and/or an output signal) of the EM sensor (e.g., the first radar). The first signal may have or may correspond to the first value of performance parameter. The ML module may be supervised by a signal of the data generator to produce a third signal that has or corresponds to a value of performance parameter that is in the same order, or substantially equal (e.g., within a predefined percentage such as 90%) to the second value of performance parameter (e.g., the second spatial resolution, the second Doppler resolution, etc.). After training the ML module to generate the third signal, the ML module may be included in an embodiment of the present invention so as to produce a signal (e.g., a spatial image such as a point cloud, a depth map, a range-Doppler map, etc.) that may be superior to the EM sensor's inherent performance, as explained herein.

A neural network (e.g., a neural network implementing machine learning), may refer herein to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g. CPUs or graphics processing units (GPUs), or a dedicated hardware device may perform the relevant calculations.

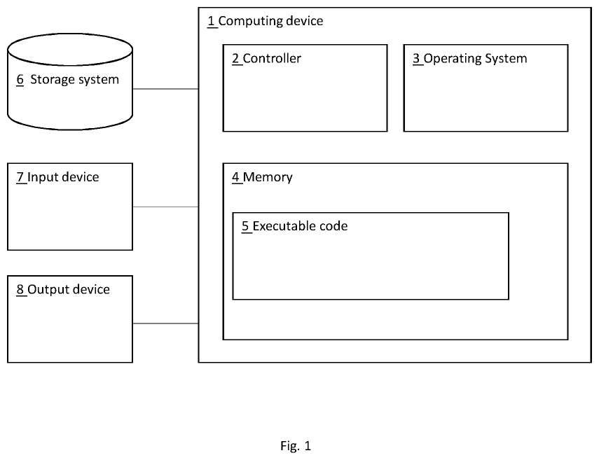

Reference is now made to FIG. 1, which is a block diagram depicting a computing device, which may be included in an embodiment of a system for enhancing a signal of an EM sensor (e.g., a radar) according to some embodiments.

Computing device 1 may include a controller 2 that may be, for example, a central processing unit (CPU) processor, a chip or any suitable computing or computational device, an operating system 3, a memory 4, executable code 5, a storage system 6, input devices 7 and output devices 8. Controller 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of, possibly different memory units. Memory 4 may be a computer or processor non-transitory readable medium, or a computer non-transitory storage medium, e.g., a RAM.

Executable code 5 may be any executable code, e.g., an application, a program, a process, task or script. Executable code 5 may be executed by controller 2 possibly under control of operating system 3. For example, executable code 5 may be an application that may enhance a signal of an EM sensor (e.g., enhance a radar performance and/or image formation), may train a NN, and/or may operate a NN during runtime, and/or perform other functions as further described herein. Although, for the sake of clarity, a single item of executable code 5 is shown in FIG. 1, a system according to some embodiments of the invention may include a plurality of executable code segments similar to executable code 5 that may be loaded into memory 4 and cause controller 2 to carry out methods described herein. Further, multiple computer systems such as those in FIG. 1 may cooperate according to embodiments of the present invention.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data such as data pertaining to one or more electromagnetic (EM) sensors (e.g., such as element 20 of FIG. 2A) and/or one or more data generators (e.g., such as element 30 of FIG. 2A) may be stored in storage system 6 and may be loaded from storage system 6 into memory 120 where it may be processed by controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., controllers similar to controller 2), a plurality of input units, a plurality of output units, a plurality of memory units, and a plurality of storage units.

Reference is now made to FIG. 2A which is a block diagram depicting a system 10 for enhancing a signal of an EM sensor (e g , enhancing performance and/or image formation of a radar), according to some embodiments.

According to some embodiments, one or more modules of system 10 may be implemented as a hardware module, a software module or any combination thereof. For example, system 10 may be implemented as one or more software processes or threads and may be run or executed by at least one computing device, such as element 1 of FIG. 1.

According to some embodiments of the invention, system 10 may include a non-transitory memory device (e.g., element 4 of FIG. 1) where modules of instruction code may be stored and a processor (e.g., element 2 of FIG. 1) that may be associated with the memory device, and configured to execute the modules of instruction code. Processor 2 may be configured to, upon execution of the modules of instruction code, perform at least one method of enhancing a performance of an electromagnetic sensor, as elaborated herein.

According to some embodiments, system 10 may receive one or more first data elements 21′ (e.g., 21A′, 21B′, 21C′, 21D′) pertaining to or describing (e.g., being a temporal or instantaneous sample of) a signal 21 (e.g., 21A, 21B, 21C, 21D) of an EM sensor 20 (e.g., a first radar) having an inherent, first performance parameter value (e.g., a first spatial resolution, a first depth resolution, a first angular resolution, a first frequency resolution, a first Doppler resolution, a first SNR and the like).

For example, in an embodiment in which EM sensor 20 is a radar, the one or more first data elements 21′ may be digitized, sampled values corresponding to a signal of reflected RF energy that may be received at the radar's antenna. One or more elements 21′ or derivatives thereof may then be input as one or more inputs to one or more ML modules, as elaborated herein, to produce an enhanced EM signal 10A, having a performance parameter value that may be superior to the first performance parameter value.

System 10 may receive one or more second data elements 31′ (e.g., 31A′) pertaining to a signal of a data generator 30 (e.g., a second radar, a radar simulator, an assembly of one or more cameras, a light detection and ranging (LIDAR) sensor, etc.) having a second performance parameter value that may be higher than or superior to the first performance parameter value. In other words, data generator 30 may produce a signal (e.g., an output image signal) that may have or may be characterized by a higher spatial resolution, a higher depth resolution, a higher angular resolution, a higher Doppler resolution, a higher frequency resolution and/or a higher SNR, in relation to that of first EM sensor 20. Additionally, or alternately, data generator 30 and EM sensor 20 may be implemented as the same entity, as elaborated herein in relation to FIG. 2D.

According to some embodiments, system 10 may be configured to train one or more supervised machine learning (ML) modules 140 (e.g., 140B, 140C, 140D) to generate an EM sensor signal 10A (e.g., a radar signal) and/or an enhanced EM sensor image (e.g., a radar image) 10B, having a performance parameter value that is higher than or superior to the first performance parameter value, as elaborated herein.

As known in the art, at a first, training stage, the one or more ML modules 140 may be trained (e.g., by supervision of an annotated data from data generator 30) to produce enhanced EM sensor signal 10A. At a second, inference, run-time or deployment stage, the one or more ML modules 140 may be utilized to generate or produce from one or more data elements 21′ or derivatives thereof (e.g., 21B′) an enhanced EM sensor signal 10A or image (e.g., a radar image) 10B, based on the training.

The one or more ML modules 140 may include one or more respective ML models 141 (e.g., 141B, 141C, 141D). The one or more ML models 141 may, for example be implemented as respective one or more neural network (NN) models of any appropriate type as known in the art, including for example, a deep-learning, supervised, NN model, etc.

The one or more ML models 141 may be adapted to receive the one or more first data elements 21′ as input data and the one or more second data elements 31′ as supervising annotated data. Additionally or alternately, the one or more ML models 141 may be trained to generate EM sensor signal 10A based on the input of the one or more first data elements 21′ (e.g., 21′A, 21B′, 21C′, 21D′), as a training data set, where the one or more second data elements 31 (e.g., 31A′) serve as annotated, supervising data.

As shown in FIG. 2A, in a stage of training, at least one ML model 141 (e.g., 141B, 141C, 141D) may be trained, as known in the art, based on a training data set of the one or more first data elements 21′ (e.g., 21A′, 21B′, 21C′, 21D′) using the one or more second data elements 31′ (e.g., 31A′, 31B′) of data generator 30 as a supervising, annotated data, as known in the art.

For example, at least one ML model 141 (e.g., 141B, 141C, 141D) may receive as input one or more first data elements 21 (e.g., 21B′, 21C′, 21D′) and may be trained, as known in the art, to minimize a cost function (e.g., a linear cost function, a quadratic cost function, and the like) of a difference between the ML model's 141 output and respective one or more data elements 31′ pertaining to or describing a signal of data generator 30.

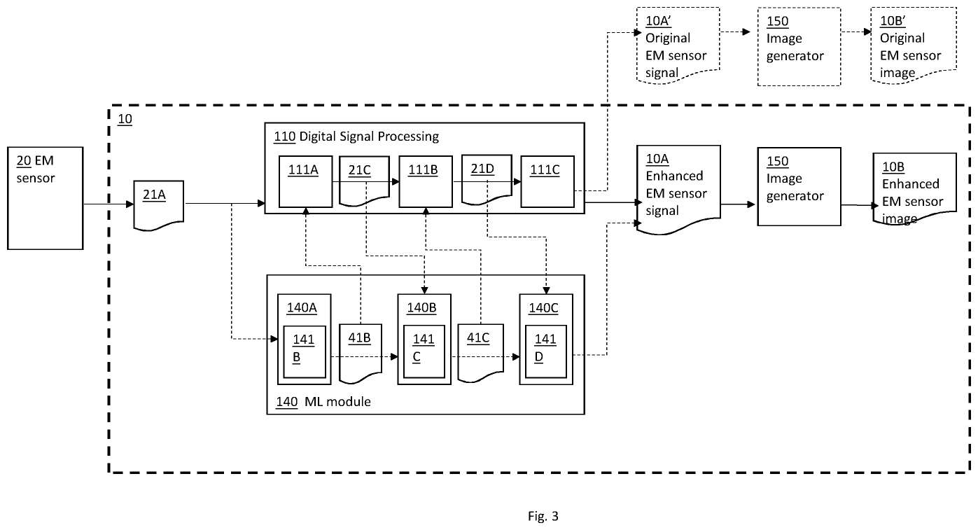

Following training of the at least one ML models 141 on a training data set of data elements 21′, system 10 may be employed at an operational stage, during which at least one trained ML module 140 (e.g., 140B, 140C, 140D) may be utilized to receive one or more first data elements 21′ (e.g., 21B′, 21C′, 21D′) of EM sensor (e.g., radar) 20, and enhance at least one inherent parameter of performance (e.g., a spatial resolution, a Doppler resolution, an SNR, etc.) of the one or more first data elements 21′, to produce an enhanced EM sensor signal (e.g., radar signal) 10A and/or enhanced EM sensor image (e.g., radar image) 10B, as elaborated herein in relation to FIG. 3.

System 10 may include one or more modules 120 (e.g., 120A, 120B) adapted to align, sort, synchronize and/or register one or more signals 21 (e.g., an output signal, such as a point cloud, a depth map, a range-Doppler map and the like) of EM sensor (e.g., radar) 20 with respective one or more signals 31 of one or more data generators 30. As elaborated herein, such alignment and/or synchronization may facilitate training of one or more ML modules 140 (and respective one or more ML models 141) in a self-supervised training process.

The term “self-supervision” may be used herein to indicate that system 10 may be deployed with EM sensor 20 and data generator 30 (e.g., in a real-world, outdoor environment) and may train one or more ML modules 140 (and one or more respective NN models 141) by receiving data elements 31′ of data generator 30 as supervisory, annotation data, without requiring additional input such as labeling data and/or annotation data (e.g., from an administrative user).

For example, at least one NN model 141 may receive as input at least one data element (e.g., 21B′) originating from EM sensor 20 and emit at least one output data element corresponding to the received at least one input data element. Embodiments of the invention may utilize the supervisory, annotation data to train the one or more NN model 141 by minimizing at least one error or difference between the at least one output data element of NN model 141 and the supervisory, annotation data, as known in the art.

For example, system 10 may receive as input one or more input signals 21 (e.g., 21A) from an EM sensor (e.g., a radar) 20, such as analog signals pertaining or describing to a reflected transmission of RF radiation, as known in the art. System 10 may further receive as input one or more input signals 31 (e.g., 31A) from data generator 30, including for example an output signal, such as a radar point cloud image, a depth map image, a range-Doppler map and the like. Synchronization module 120A may be configured to perform at least one of:

sample the one or more signals 21A, 31A, as known in the art;

perform an analog to digital conversion of the sampled one or more signals 21A, 31A, to produce respective one or more digital data elements 21A′, 31A′, as known in the art; and

synchronize between a first timing of the reception of the one or more first data elements 21A′ (e.g., of EM sensor 20) and a second timing of the reception of the one or more second data elements 31A (e.g., of the one or more data generators 30), to produce respective, synchronized one or more digital data elements 21B′, 31B′, as known in the art.

The implementation of synchronization module 120A may depend upon the characteristics of EM sensor 20 and the one or more data generator 30. For example, the implementation of synchronization module 120A may depend on a rate of signals 31A and 21A, the duration of the signals 21A and 31A, a format (e.g., an analog format, a digital format, etc.) of received signals 21A and 31A and a relative timing of signals 21A and 31A, but may be apparent to a person skilled in the art of signal processing.

Synchronization module 120 may include a spatial registration module 120B, configured to perform spatial registration or alignment between the one or more first data elements 21A′ of EM sensor 20 and the one or more respective second data elements 31A′ of the one or more data generators 30. For example, EM sensor (e.g., a radar) 20 may scan a first field of view, and data generator (e.g., a LIDAR sensor) 30 may scan a second field of view, which may be different (e.g., panned, tilted, etc.) from the first field of view. Spatial registration module 120B may align or register spatial data conveyed by the one or more first data elements 21A′ and the one or more second data elements 31A′. For example, spatial registration module 120B may crop or align the fields of view of EM sensor 20 and data generator 30.

The implementation of spatial registration module 120B may depend upon the characteristics of EM sensor 20 and the one or more data generator 30. For example, spatial registration module 120B may depend upon a span of the presented spatial data such as a depth of the scanned volume of space and a field of view of the scanned space, the resolution of the spatial data, and the like, but may be apparent to a person skilled in the art of signal processing.

As elaborated herein, at least one ML module 140 (e.g., 140B) may be trained by supervision of one or more data elements 31A′ pertaining or describing to one or more data generators 30 (e.g., a second radar, a LIDAR sensor or a radar simulator, as explained herein). According to some embodiments, the one or more supervising data elements 31A′ may be an output of the one or more data generators 30. For example, supervising data 31A′ may be an image produced by data generator 30, including for example, a point cloud, a depth map and the like.

As elaborated herein in relation to FIG. 3, after a training stage is concluded, the at least one ML module (e.g., 140B) may be applied, concatenated or appended to signal 21A (and/or respective data element 21A′) of EM sensor 20 to produce an enhanced EM sensor signal 10A. For example, signal 21A may be a radar image such as a point cloud, depth map, a range-Doppler map and the like, and the at least one ML module (e.g., 140B) may be applied to produce an enhanced radar signal 10A and/or an enhanced radar image 10B, as elaborated herein.

Additionally, or alternately, at least one ML module 140 (e.g., 140B, 140C) may be trained by supervision of one or more data elements 31′ pertaining to one or more data generators 30, where the one or more supervising data element 31′ may be or may include internal signals of the one or more data generators 30.

For example, in an embodiment where EM sensor is a first radar and data generator 30 is a second radar, data element 31A′ may be or may correspond to a digital signal 31A that may representing a received reflection of RF energy, as known in the art. As elaborated in relation to FIG. 3, after the training has concluded, at least one ML module 140 (e.g., 140B, 140C) may be applied, concatenated or appended to a respective signal 21 (e.g., 21A) of radar 20 to produce an enhanced radar signal 10A and/or an enhanced radar image 10B.

As shown in FIG. 2A, system 10 may receive data from at least two sources:

System 10 may receive one or more first data elements 21′ (e.g., 21A′) pertaining to a signal 21 (e.g., 21A), such as an output signal of an electromagnetic (EM) sensor 20 (e.g., a radar). EM sensor 20 (and hence the one or more first data elements 21′) may have or may be characterized by an intrinsic, first value of a performance parameter (e.g., a first spatial resolution, a first Doppler resolution, and the like).

System 10 may further receive one or more second data elements 31′ (e.g., 31A′) pertaining to a signal 31 (e.g., 31A′) such as an output signal of one or more data generators 30 having a second value of the performance parameter (e.g., a second spatial resolution, a second Doppler resolution, and the like) that is superior to or higher than the first value of performance parameter (e.g., the first spatial resolution, the first Doppler resolution, etc.).

According to some embodiments, the one or more of second data elements 31′ (e.g., 31A′) may be or may pertain to an output signal 31 of one or more data generators 30, including for example a point cloud generated by the data generator, a depth map generated by the data generator and a range-Doppler map generated by the data generator.

According to some embodiments, system 10 may include a digital signal processing (DSP) module 110, configured to receive synchronized signal 21B, and may be adapted to apply one or more operations of signal processing on synchronized signal 21B en-route producing an EM sensor (e.g., a radar) signal (10A, 10A′). Produced signal 10A may in turn be presented by a computing device (e.g., element 1 of FIG. 1) such as image generator 150 as an EM sensor image on a screen (e.g., a radar image on a radar screen, such as output element 8 of FIG. 1).

According to some embodiments, DSP module 110 may have or may include one or more (e.g., a plurality of) processing modules 111.

The one or more operations of signal processing may be applied by respective processing modules 111 (e.g., 111B, 111C, 111D, etc.), and may include signal processing operations as known in the art of signal processing (e.g., radar signal processing). For example, in embodiments where EM sensor 20 is a radar, processing modules 111 (e.g., 111B, 111C, 111D, etc.) may include:

a sampling (e.g., an up-sampling) module, configured to sample received signal 21A (or synchronized signal 21B, as explained herein) in an implementation where 21A (or 21B) is a continuous signal;

an analog to digital (A2D) conversion module, in an implementation where 21A (or 21B) is an analog signal;

a gain module (e.g., an analog gain module, a digital gain module, etc.), configured to control a gain of signal 21A (or 21B);

a thresholding module, configured to modify signal 21A (or 21B) according to a predefined or adaptive threshold;

one or more filtering modules (e.g., an adaptive band-pass filter, a clutter filter and the like), configured to filter sampled signal 21A (or 21B);

a range ambiguity resolution module, as known in the art; and

a frequency ambiguity resolution module, as known in the art.

Additional processing modules 111 may be included in DSP module 110 as known in the art, according to the specific implementation of EM sensor (e.g., radar) 20, en-route creation of an EM sensor signal 10A′ and/or an enhanced EM sensor signal 10A as elaborated herein. EM sensor signal 10A′ and/or an enhanced EM sensor signal 10A may in turn be presented by an image generator 150 as an image (e.g., a radar image) 10B′ and/or an enhanced image 10B, as elaborated herein.

System 10 may include at least one ML module 140 (e.g., 140B) that may be or may include at least one respective supervised ML model 141 (e.g., 141B). The at least one ML model 141 may be configured to receive one or more first data elements 21′ (e.g., 21A′, 21B′) pertaining or corresponding to received signal 21 (e.g., 21A or synchronized signal 21B) of EM sensor 20 and one or more second data elements 31′ (e.g., 31A′, 31B′) pertaining to a signal 31 (e.g., 31A, 31B) of data generator 30.

Embodiments of the present invention may include training the at least one supervised ML model 141 to generate an enhanced EM sensor signal 10A based on the one or more first data elements 21′ (e.g., 21A′, 21B′): the one or more first data elements 21′ (e.g., 21A′) may be used or may serve as a training data set; and the one or more second data elements 31′ (e.g., 31A′) may be used or may serve as supervising annotated data or labeled data for training the at least one ML model 141.

According to some embodiments, training at least one ML model 141 to generate an enhanced EM sensor signal may include using one or more output data elements (e.g., 21C′) of one or more ML models as a training data set, as elaborated herein.

EM sensor signal 10A may be enhanced in a sense that it may have or may be characterized by a performance parameter value that is superior to or higher than the first performance parameter value. Additionally or alternately, EM sensor signal 10A may be utilized (e.g., by an image generation module 150) to present or produce (e.g., on a screen) an EM sensor image 10B that may be superior (e.g., have higher SNR, resolution etc.) in relation to the EM' s original or inherent image 10B′

In some embodiments, the one or more first data elements 21′ (e.g., 21A′) may be or may include, for example an output image of EM sensor 20. For example, in embodiments where EM sensor 20 is a radar, the one or more first data elements 21′ (e.g., 21A′) may be a point cloud, a depth map and/or a range-Doppler map. ML model 141 (e.g., 141B) may generate or produce from the one or more first data elements 21′ (e.g., 21A′) an enhanced EM sensor signal 10A (e.g., an enhanced radar image such as a point cloud or a depth map), using the one or more second data elements 31′ (e.g., 31A′) of data generator 30 as supervisory, annotated data. The enhanced EM sensor signal 10A may be enhanced in a sense that it may have a performance parameter value (e.g., an angular resolution, a Doppler resolution, an SNR etc.) that may be superior to or higher than the performance parameter value of the one or more first data elements 21′ (e.g., 21A′). For example, the enhanced EM sensor signal 10A may be in the order of the performance parameter value of the one or more second data elements 31′ (e.g., 31A′).

Additionally, or alternately, and as shown in FIG. 2A, system 10 may include one or more (e.g., a plurality of) ML modules 140 (e.g., 140B, 140C, 140D, etc.), each configured to enhance a different aspect, portion or stage of the EM sensor. For example, each ML module 140 may be configured to enhance an internal or a partially processed signal 21 (e.g., 21C, 21D) and/or respective data elements 21′ (e.g., 21C′, 21D′) of DSP module 110.

Embodiments of the invention may receive one or more data elements 21′ (e.g., 21B′, 21C′) pertaining or corresponding to partially processed signals 21 (e.g., 21B, 21C) or data elements from DSP module 110, as inputs to respective ML models 141 (e.g., 141B, 141C). Embodiments of the invention may apply the ML models 141 on the received, partially processed signals or data elements 21′ (e.g., 21B′, 21C′) to produce an enhanced EM sensor signal (e.g., an enhanced radar signal) 10A. The term enhanced may be use in this context to refer to a signal that may have a superior or higher performance parameter value, such as a higher spatial resolution, a higher SNR, etc., in relation to radar EM sensor signal (e.g., radar signal) 10A′, and may be used by an image generator 150 to produce an enhanced EM sensor image (e.g., an enhanced radar image) 10B that has a superior or higher performance parameter value (e.g., a higher Doppler resolution, a higher SNR, etc.) in relation to radar image 10B′.

Additionally, or alternately, the one or more ML models may be arranged or configured in a cascaded formation, where an output of a first ML model (e.g., 140B) may be input to a subsequent ML module 140 (e.g., 140C).

In some embodiments, training of at least one ML model to generate an enhanced EM sensor signal may include using an output of a preceding ML model as supervisory annotated data, as elaborated herein. Additionally, or alternately, training of at least one ML model to generate an enhanced EM sensor signal may include using an output of a preceding ML model as a training data set, as elaborated herein.

System 10 may receive an unprocessed or a partially processed signal 21 (e.g., 21A, 21B) from EM sensor 20. For example, in embodiments where EM sensor 20 is a radar, signal 21 may be or may correspond to an analog signal pertaining to reception of reflected RF energy by an antenna of radar 20. The one or more first data elements 21′ (21A′, 21B′) may be or may pertain or correspond to input signal 21 (e.g., 21A, 21B). For example, the one or more first data elements 21′ (21A′, 21B′) may pertain to (e.g., be a timewise sample of) input signal 21 (21A, 21B), as known in the art.

One or more processing modules 111 (e.g., 111B) of DSP module 110 may apply respective one or more processing operations (e.g., up-sampling, filtering, etc.), as elaborated herein, on the one or more received first data elements 21′ (e.g., 21B′) to produce one or more processed data elements 21 (e.g., 21C′). One or more ML models 141 (e.g., 141C) may receive the one or more processed data elements 21′ (e.g., 21C′), and generate or produce from the received processed data elements (e.g., 21C′) an enhanced radar signal 10A, using at least one data element 31′ (e.g., 31B′) pertaining or corresponding to a signal (e.g., an output signal, such as synchronized output signal 31B) of data generator 30 as supervisory data.

Additionally, or alternately, the one or more ML models 140 may be arranged in a cascade, where an output of a first ML model (e.g., 141C) may be presented as input to subsequent one or more ML models 141 (e.g., 141D). For example:

one or more first ML models 141 (e.g., 141C) may produce one or more intermediary data elements 41 (e.g., 41D);

one or more second ML models 141 (e.g., 141D) may receive as a training data set one or more processed data elements 21′ (e.g., 21D′);

the second one or more second ML models 141 (e.g., 141D) may also receive (e.g., as supervisory, annotated data) the one or more one or more intermediary data elements 41 (e.g., 41D) from antecedent or previous ML models 141 (e.g., 141C); and

the second one or more second ML models 141 (e.g., 141D) may generate or produce from the received processed data elements 21′ (e.g., 21D′) an enhanced EM sensor signal 10A, using as supervisory data an output from an antecedent ML model (e.g., 141C).

Additionally, or alternately, any combination of one or more DSP operations by processing modules 111 (e.g., 111B, 111C, 111D) and the cascade of ML modules 140 (140B, 140C, 140D) may be implemented. For example:

(a) One or more first ML models 141 (e.g., 141B) may receive one or more data elements 21′ (e.g., 21B′), and generate (e.g., by supervision of signal 31B′) one or more ML output data elements (e.g. 41B). The one or more data elements 41B may be enhanced by ML model 141B in relation to the received one or more data elements 21B′, in a sense that it may have or be characterized by one or more superior or higher performance parameter values (e.g., a performance parameter value in the order of the supervising data (e.g., 31A′)) in relation to the received one or more data elements 21′ (e.g., 21B′).

(b) The one or more data elements (e.g., 41B) may be directed as input to a respective processing module (e.g., 111B).

(c) The processed output signal (e.g., 21C) and/or respective data element (e.g., 21C′) of the processing module (e.g., 111B) may be enhanced EM sensor signal 10A. Alternately, processed output signal (e.g., 21C) and/or respective data element (e.g., 21C′) of the processing module (e.g., 111B) may be directed as an input to one or more respective second ML models (e.g., 141C).

(d) The output of the one or more second ML model (e.g., 141C) may be an enhanced radar signal 10A. Alternately, the output of the one or more second ML model (e.g., 141C) may be directed as input to a respective processing module (e.g., 111C).

Steps (c) and (d) may repeat according to the specific implementation of system 10, including a specific implementation of the cascade of ML modules 140 and a specific configuration of processing modules 111 in DSP module 110.

As shown in FIG. 2A, system 10 may include an image generator module 150, configured to receive generated enhanced EM sensor signal 10A and generate therefrom an enhanced EM sensor image 10B that may be presented on an output device (e.g., element 8 of FIG. 1) such as a screen. According to some embodiments, enhanced EM sensor signal 10A may be or may include one or more data elements pertaining to an enhanced image 10B (e.g., a point cloud, a depth map, a range Doppler map, etc) Enhanced image 10B may be enhanced in a sense that a value of a performance parameter (e.g., a spatial resolution, an angular resolution, a Doppler resolution, etc.) of image 10B may be superior to or higher than a performance parameter value of received signal 21A and/or respective data element 21A′. In some embodiments, enhanced image 10B may have or may be characterized by a value of a performance parameter that may be in the order of the performance parameter value of the one or more data generators 30. In other words, enhanced image 10B may be enhanced in a sense that a value of a performance parameter (e.g., a spatial resolution, a Doppler resolution) of generated radar image 10B may be superior to that of an original EM sensor image that may be produced by image generator module 150 from signal 21 (e.g., 21A), as shown by the dotted line in FIG. 2A.

Reference is now made to FIG. 2B which is a simplified block diagram depicting a system 10 for enhancing EM sensor performance according to some embodiments.

As shown in FIG. 2B, system 10 may receive one or more first data elements 21′ (e.g., 21A′) that may pertain to a signal (e.g., an output signal) of EM sensor 20. For example, the one or more first data elements 21A′ may include information pertaining to an amplitude, timing, phase and/or direction of an electromagnetic radiation received by a radar 20, as known in the art. Alternately, or additionally, the one or more first data elements 21A′ may include information pertaining to a point cloud and/or a depth map which may be presented (e.g., on a screen) by radar 20, as known in the art.

System 10 may include a signal processing module 110 configured to receive at least one of the one or more first data elements 21A′ and extract therefrom one or more processed data elements 21′ (e.g., 21B′).

As shown in FIG. 2B, system 10 may include an ML module 140, that may be or may include one or more supervised ML models 141 (e.g., 141B, 141C). ML models 141 may, for example be implemented as an NN of any appropriate type as known in the art, including for example, a deep-learning NN. ML model 141 may be configured to receive one or more first data elements (e.g., 21A′, 21B′) originating from radar 20 and one or more second data elements (e.g., 31A′, 31B′) originating from data generator 30, and produce or generate an enhanced radar signal 10A, as elaborated herein.

System 10 may train supervised ML model 141B to generate enhanced radar signal 10A based on the one or more first data elements (e.g., 21A′, 21B′), where the one or more second data elements (e.g., 31A′, 31B′) may serve as supervising annotated or labeled data.

Generated signal 10A may be enhanced in a sense that it may correspond to a value of a performance parameter (e.g., a spatial resolution, a Doppler resolution) that may be in the order of the second value of a performance parameter (e.g., the second spatial resolution, the second Doppler resolution) of the one or more data generators 30 that may be superior to the inherent, first value of a performance parameter (e.g., the first spatial resolution, the first Doppler resolution) of EM sensor (e.g., radar) 20.

As shown in FIG. 2B, during training of the one or more data ML models 141 (e.g., 141B, 141C) of ML module 140, models 141 may receive a first data element input having or pertaining to a first format or domain, and may receive a second, supervisory data input, pertaining to or having a second format or domain. In other words, the one or more data ML models 141 may be trained on a first type of data as a training set, according to annotated supervision of a different type of data, in a process that is commonly referred to in the art as “domain transfer”.

For example, as depicted in the example of FIG. 2B, one or more data elements 31′ (e.g., 31A′, 31B′), such as an output signal (e.g., a point cloud, a depth map and the like) of data generator 30 (e.g., a LIDAR detector) may be used as supervisory, annotated data to supervise a training of one or more ML models 141. For example, a first ML model (e.g., 141A) may receive as input one or more first data elements (e.g., 21A′) such as sampled, digitized data elements, pertaining to a received levels of RF radiation, and a second ML model (e.g., 141B) may receive as input one or more processed, second data elements (e.g., 21B′) from DSP module 110. The one or more ML models 141 (e.g., 141B, 141C) may receive one or more (e.g., a plurality of) input data elements that may pertain to different formats (e.g., have different format of signals) or different domain (e g , a time domain, a frequency domain, etc.), but may both be trained on their respective inputs, with the same supervisory data (e.g., the one or more data elements 31A′).

As elaborated herein, system 10 may receive one or more first signals 21 (e.g., 21A) and/or respective data elements 21′ (e.g., 21A′) pertaining to an EM sensor (e.g., a radar) 20 that may have an inherent, first value of a performance parameter (e.g., a first spatial resolution, a first Doppler resolution, a first angular resolution, a first SNR and the like) and one or more second signals 31 (e.g., 31A) and/or respective data elements 31′ (e.g., 31A′) pertaining to a data generator (e.g., a second radar) having an inherent, second value of the performance parameter (e.g., a second spatial resolution, a second Doppler resolution and the like) that is superior or higher than the value of the performance parameter (e.g., the first spatial resolution).

As shown in FIG. 3, image generator 150 may receive the generated enhanced EM sensor (e.g., radar) signal 10A and construct therefrom an enhanced EM sensor (e.g., radar) image 10B that may have a performance parameter value (e.g., the second spatial resolution, the second Doppler resolution, etc.) that may be in the order of the second value of a performance parameter, based on enhanced radar signal 10A. In other words, enhanced EM sensor (e.g., radar) image 10B may be enhanced in a sense that a value of a performance parameter (e.g., a spatial resolution, a Doppler resolution) of generated EM sensor (e.g., radar) image 10B may be superior to that of an original EM sensor (e.g., radar) image that may be produced by image generator module 150 from EM sensor (e.g., radar) signal 21, as shown by the dotted line in FIG. 3.

According to some embodiments, data generator 30 may be or may include an EM sensor other than EM sensor 20. For example, data generator 30 may be or may include a radar, a light detection and ranging (LIDAR) sensor or detector and an assembly of one or more cameras. Additionally, data generator 30 may have or be characterized by at least one performance parameter value that may be superior to or higher than a respective performance parameter value of EM sensor (e.g., radar) 20.

For example, in an embodiment where EM sensor 20 is a first radar and data generator 30 is a second radar other than radar 20, radar 30 may be selected to have a higher pulse repetition frequency (PRF) than that of radar 20, and may thus have a superior spatial (e.g., angular) resolution and/or superior resilience to motion blur. One or more ML modules 140 (e.g., 140B) may be trained on a training data set of data elements 21′ (e.g., 21A′) from radar 20, having data elements 31′ (e.g., 31A′) of radar 30 as supervisory annotation data, and may subsequently produce an enhanced radar signal 10A that may compensate for radar 20′s inferior angular resolution and/or susceptibility to error due to motion blur.

In another example, in an embodiment where data generator 30 may be a LIDAR sensor, LIDAR 30 may, as known to persons skilled in the art, have a superior spatial (e.g., depth) resolution in relation to that of radar 20 at close ranges (dependent on specific radar parameters). One or more ML modules 140 (e.g., 140B) may be trained on a training data set of data elements 21′ (e.g., 21A′) from radar 20, having data elements 31′ (e.g., 31A′) of LIDAR 30 as supervisory annotation data, and may subsequently produce an enhanced radar signal 10A that may compensate for radar 20′s inferior depth resolution at close range.

In another example, in an embodiment where data generator 30 may be a Doppler radar, Doppler radar 30 may demonstrate a superior Doppler resolution (e.g., resolution or accuracy of velocity measurement of one or more objects in the direction of the radar's line of sight) in relation to that of radar 20. One or more ML modules 140 (e.g., 140B) may be trained on a training data set of data elements 21′ (e.g., 21A′) from radar 20, having data elements 31′ (e.g., 31A′) of Doppler radar 30 as supervisory annotation data, and may subsequently produce a radar signal 10A that may compensate for radar 20′s inferior Doppler resolution.

As elaborated herein, the received input data element 21′ (e.g., 21A′) from EM sensor (e.g., radar) 20 and data element 31′ (e.g., 31A) of data generator 30 may be synchronized by one or more synchronization modules 120 (e.g., time-wise synchronization 120A and/or spatial registration and aligning module 120B), to produce respective synchronized data elements 21B′ and 31B′. The synchronization and alignment of 21B′ and 31B′ may enable embodiments of the present invention to train at least one ML model 141 (e.g., 141A, 141B, etc.) in a self-supervised process. In other words, during training of at least one ML model 141, ML model 141 may be supervised by input (e.g., 31B′) from one or more data generators 30 as annotated supervisory data and may not require intervention or introduction of data from any entity (e.g., labeling by a human administrator) other than the one or more data generators 30.

Such a self-supervised training process may provide a number of improvements or benefits over state-of-the-art systems, including for example:

facilitating seamless, continuous training, in a sense that it may be performed using real-world data, and may not require labeling or annotation of the supervisory data;

providing automated training that is independent in a sense that it may not require human intervention or supervision; and

rapid, in a sense that an embodiment of system 10 may be continuously trained on data that may be received in real-time.

Reference is now made to FIG. 2C which is a block diagram depicting a system 10 for enhancing an EM sensor's performance and/or image formation, according to some embodiments.

As known in the art, simulators for spatial imaging systems such as radars may be configured to produce a simulated, three-dimensional (3D) environment representing a real-world 3D environment. Simulators may be configured to generate a signal that may pertain to the simulated, 3D environment. For example, simulators may generate a signal that may emulate at least one input signal that a spatial imaging system (e.g., EM sensor 20) may receive from the simulated 3D environment, as if it was a real-world 3D environment.

According to some embodiments, at least one data generator 30 may be or may include a simulator module. Simulator module 30 may be implemented for example, as a software module, and may be executed by one or more processors (e.g., element 2 of FIG. 1) of one or more computing devices (e.g., element 1 of FIG. 1).

As explained herein, simulator module 30 may be configured to produce a simulated, 3D environment and generate or emit an output signal 31 (e.g., 31A) and/or respective data element 31′ (e.g., 31A′), representing an ideal, simulated output (e.g., an EM sensor image such as a point cloud or a depth map) of EM sensor 20. The output may be ideal in a sense that it may represent an output of EM sensor (e.g., a radar) 20 that is devoid of noise, disturbances or other real-world artifacts (e.g., due to sampling) that may normally diminish the function or performance of EM sensor 20 in the real world. As explained herein, signal 31 (e.g., 31A) and/or respective data element 31′ (e.g., 31A′) may be characterized by a value of a performance parameter (e.g., a spatial resolution, a Doppler resolution, etc.) that may be superior or higher than a respective, inherent value of a performance parameter of EM sensor 20 (e.g., a radar).

Alternately, signal 31 (e.g., 31A) and/or respective data element 31′ (e.g., 31A′) may emulate an internal signal of EM sensor 20, that may be produced by EM sensor 20 (e.g., in response to receiving reflected RF energy from a real world 3D environment), equivalent to or as represented by the simulated 3D environment. As explained herein, signal 31 (e.g., 31A) and/or respective data element 31′ (e.g., 31A′) may be ideal in a sense that it may represents a preprocessed signal of EM sensor (e.g., radar) 20 that is devoid of noise, disturbances or other real-world artifacts.

Signal 31F and/or respective one or more data elements 31F′ may be generated or produced by simulator 30 and may be presented as input to EM sensor 20. 31F and/or 31F′ may be characterized by a value of performance parameter (e.g., a spatial resolution, a Doppler resolution, etc.) that may be equivalent to a respective, inherent value of performance parameter of EM sensor (e.g., radar) 20, and may be inferior to, or lower than the value of performance parameter characterizing signal 31A and/or respective one or more data elements 31A′. In other words, signal 31F and/or respective one or more data elements 31F′ may be an emulation of an input signal (e.g., a signal corresponding with reflection of transmitted RF energy) from a real-world 3D environment, as represented by the simulated 3D environment. Signal 31B may correspond to an inherent value of performance parameter (e.g., a spatial resolution, a Doppler resolution, etc.) of EM sensor (e.g., radar) 20.

As explained herein, in relation to data generators 30 other than a simulator (e.g., LIDARs, radars, assemblies of one or more cameras and the like), embodiments of the invention may include training of one or more supervised ML models (e.g., 141B, 141C) to generate an enhanced EM sensor signal 10A and/or an enhanced EM sensor image 10B that is enhanced in relation to the EM sensor's inherent performance (e.g., having a higher value of a performance parameter).

For example, simulator 30 may emit:

a first signal 31A, of an ideal (e.g., devoid of noise), superior (e.g., of a superior value of performance parameter) emulated EM sensor (e.g., radar) output (e.g., a point cloud, a depth map and the like) pertaining to a simulated 3D environment; and

a second signal 31F and/or respective one or more data elements 31F′, emulating the 3D environment as input to EM sensor (e.g., radar) 20.

EM sensor (e.g., radar) may receive signal 31F and/or respective one or more data elements 31F′ as input and produce one or more signals 21 (e.g., 21B) and/or respective one or more data elements 21′ (e.g., 21B′), as elaborated herein.

One or more ML models 141 (e.g., 141B) may be trained by receiving one or more data elements 21′ (e.g.21B′) as a training data set, using one or more data elements 31′ (e.g., 31A′) as supervising annotated data for the supervised training of ML model 141.

Additionally, or alternately, simulator 30 may emit an ideal (e.g., devoid of noise), superior (e.g., of a superior value of performance parameter) emulated preprocessed EM sensor (e.g., radar) signal 31A (e.g., an internal signal of EM sensor 20). One or more ML model 141 (e.g., 141B) may be trained on one or more data elements 21′ (e.g., 21B′) of preprocessed EM sensor signal 21 (e.g., 21B), where one or more data elements 31′ (e.g., 31A′) of signal 31 (e.g., 31A) may serve as supervising, annotated data for the supervised training of the one or more ML model 141 (e.g., 141B).

Reference is now made to FIG. 2D which is a block diagram depicting a system 10 for enhancing an EM sensor signal, according to some embodiments.

As shown in FIG. 2D, EM sensor 20 and data generator 30 may be implemented as the same entity (e.g., marked as element 50). For example, EM sensor 20 and data generator 30 may both be implemented as a single EM sensor such as a single radar.

Element 50 may emit one or more data elements of a first EM sensor (e.g., radar) output signal 21 (e.g., 21A) and/or respective one or more data elements 21′ (e.g., 21A′) having a first performance parameter value and one or more data elements of a second EM sensor output signal 31 (e.g., 31A) and/or respective one or more data elements 31′ (e.g., 31A′) having a second performance parameter value that may be higher than or superior to the first performance parameter value, as elaborated herein.

In this configuration, one or more ML models 141 may receive the one or more first data elements 21A′ (or a synchronized version thereof 21B′) as a first input and a one or more second data elements 31A′ (or a synchronized version thereof 31B′) as a second, input. The one or more ML models 141 may use the one or more first data elements 21A′ as a training data set and use the one or more second data elements 31A′ as annotated supervisory data, so as to train to produce one or more enhanced EM sensor signal 10A.

For example, element 50 may include an EM sensor such as a radar, configured to produce one or more first data elements 31A′, pertaining to a signal of reflection of RF energy from a target, as known in the art. The one or more first data elements 31A′ may have or may be characterized by a first performance parameter value (e.g., a first SNR, a first spatial resolution, etc.). Element 50 may further include a signal processing unit 51, that may be configured to produce from the one or more first data elements 31A′ one or more second data elements 21A′ pertaining to reflection of RF energy from a target, having a second performance parameter value. In some embodiments the second performance parameter value may be degraded in relation to the first performance parameter value (e.g., a lower SNR, a lower spatial resolution, etc.).

For example, signal processing unit 51 may be or may include a noise generator, a low-pass filter, etc., and may purposefully implement degradation of or more first data elements 31A′ to produce respective one or more second, degraded data elements 21A′ and simulate an environmental condition that may be imposed (e.g., due to bad weather) on the one or more first data elements 31A (e.g., so as to produce a noisier signal, a lower resolution image, etc.). One or more ML models 141 may receive the one or more degraded data elements 21A′ and may be trained under supervision of the superior one or more superior data elements 31A′, as known in the art.

Subsequently, when deployed in an operational stage or an inference stage as commonly referred to in the art (e.g., after a training stage), system 10 may utilize the trained one or more ML models 141 to enhance an input signal including one or more data elements 21A′, so as to produce an enhanced EM sensor signal (e.g., a radar signal) 10A.

Reference is now made to FIG. 3 which is a block diagram depicting a system 10 for enhancing EM sensor (e.g., radar) performance and/or image formation, according to some embodiments. As shown in FIG. 3, after a training stage of the one or more ML modules (e.g., 140B) has concluded, the one or more ML modules may be inferred, as commonly referred to in the art, to signals and/or data elements of EM sensor 20 in run time.

For example, the one or more ML modules may be applied, concatenated or appended to a respective signal 21 (e.g., 21A) and/or respective one or more data element 21′ (e.g., 21A′) of EM sensor 20 (e.g., a radar) to produce an enhanced EM sensor signal 10A and/or an enhanced EM sensor image 10B. The inputs and outputs of the one or more ML models 141 and the one or more processing models 111 may be connected in the same way as during the training stage, and as elaborated herein in relation to FIG. 2A.

As shown in FIG. 3, system 10 may include an image generator module 150, configured to receive generated enhanced EM sensor (e.g., radar) signal 10A and construct therefrom an enhanced EM sensor (e.g., radar) image 10B that may be presented (e.g., on an output device 8 of FIG. 1, such as a radar screen) Enhanced EM sensor image 10B may have a value of a performance parameter (e.g., a spatial resolution, a Doppler resolution) that is in the order of the superior performance parameter value (e.g., resolution) of data generator 30. In other words, enhanced EM sensor image 10B may be enhanced, in relation to the original, inherent image of EM sensor 20, in a sense that a value of a performance parameter (e.g., a spatial resolution, a Doppler resolution) of generated, enhanced EM sensor (e.g., radar) image 10B may be superior to that of an original EM sensor (e.g., radar) image 10B′ that may be produced from original EM sensor (e.g., radar) signal 10A′ by image generator module 150.

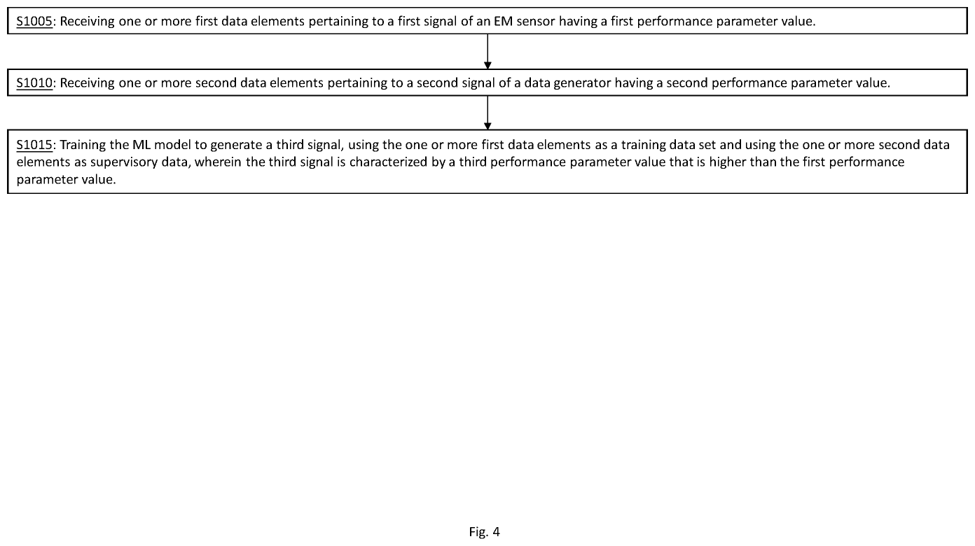

Reference is now made to FIG. 4, which is a flow diagram, depicting a method of training a machine learning based model 140 (e.g., elements 140B, 140C, 140D of FIG. 2A) to enhance a performance of an electromagnetic sensor (e.g., element 20 of FIG. 2A).

As shown in step S1005, the at least one processor (e.g., element 2 of FIG. 1) may receive one or more first data element (e.g., element 21A′ of FIG. 2A) pertaining to a first signal (e.g., element 21A of FIG. 2A) of an EM sensor (e.g., element 20 of FIG. 2A), having a first performance parameter value (e.g., a first spatial resolution value, a first Doppler resolution value, and the like).

As shown in step S1010, the at least one processor 2 may receive one or more second data elements (e.g., element 31A′ of FIG. 2A) pertaining to a second signal (e.g., element 31A′ of FIG. 2A) of a data generator (e.g., element 30 of FIG. 2A) having a second performance parameter value (e.g., a second spatial resolution value, a second Doppler resolution value, and the like).

As shown in step S1015, the at least one processor 2 may train the ML model 140 (e.g., elements 140B, 140C, 140D of FIG. 2A) to generate a third signal (e g , enhanced EM sensor signal 10A of FIG. 2A), using the one or more first data elements (e.g., element 21A′ and/or derivatives thereof such as 21B′, 21C′ 21D′ of FIG. 2A) as a training data set and using the one or more second data elements (e.g., element 31A′ and/or derivatives thereof such as element 31B′ of FIG. 2A) as supervisory data. The third signal (e.g., 10A) may have or may be characterized by a third performance parameter value that may be superior to or higher than the first performance parameter value (e.g., higher than the first spatial resolution value, higher than the first Doppler resolution value, and the like).

Embodiments of the present invention provide a practical application for enhancing or improving performance of a spatial imaging system that may be based on a remote sensing detector or sensor such as an electromagnetic sensor, including for example a radar.

Embodiments of the present invention provide an improvement over state-of-the-art spatial imaging systems and methods by training one or more machine learning modules to enhance performance of a spatial imaging system so as to exhibit superior performance in relation to the spatial imaging system's original, inherent performance.

Embodiments of the present invention may provide an improvement over state-of-the-art spatial imaging systems and methods by enhancing an output signal of the spatial imaging system such as a radar image (e.g., a point cloud and/or a depth map).

In addition, embodiments of the present invention may be implemented to provide an improvement over state-of-the-art spatial imaging systems and methods by enhancing one or more intermediary signals corresponding to the remote sensing system (e.g., the radar). For example, as elaborated in relation to FIG. 2A, embodiments of the present invention may enhance or improve intermediary signals and/or data elements (e.g., 21C′, 21D′) within a digital signal processing stream of EM sensor 20.

In addition, embodiments of the present invention may provide an improvement over state-of-the-art spatial imaging systems and methods by training the one or more ML modules in a self-supervised training process. As elaborated herein, during a training stage, the one or more ML modules may be self-supervised by supervisory data originating from data generator 30. The supervisory data may have or may be characterized by superior performance parameters in relation to EM sensor 20. Thus, embodiments of the present invention may avoid a need to provide (e.g., by a human user) supervisory, annotated data to the one or more ML models. Instead, embodiments of the invention may be deployed in a real-world environment (e.g., at a corner of a street) and may be self-trained by the changing scenery.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. Further, features or elements of different embodiments may be used with or combined with other embodiments.

1. A method for training a machine learning (ML) model to enhance a performance of an electromagnetic (EM) sensor, the method comprising:
receiving one or more first data elements pertaining to a first signal of an EM sensor having a first performance parameter value;
receiving one or more second data elements pertaining to a second signal of a data generator having a second performance parameter value; and
training the ML model to generate a third signal, using the one or more first data elements as a training data set and using the one or more second data elements as supervisory data,
wherein the third signal is characterized by a third performance parameter value that is higher than the first performance parameter value.

2. The method of claim 1 wherein the performance parameter is selected from a list consisting of: a spatial resolution, a temporal resolution, a frequency resolution, a Doppler resolution an angular resolution and a signal-to-noise ratio (SNR).

3. The method of claim 1, wherein the one or more second data elements are selected from a list consisting of a point cloud generated by the data generator and a depth map generated by the data generator and a range-Doppler map generated by the data generator.

4. The method of claim 1, further comprising:
synchronizing between a first timing of the reception of the one or more first data elements and a second timing of the reception of the one or more second data elements; and
performing spatial registration between the one or more first data elements and the one or more second data elements,
wherein the ML is self-supervised by the one or more second data elements.

5. The method of claim 2, wherein the EM sensor is a radar and wherein the data generator is selected from a list consisting of: the radar, a second radar, a light detection and ranging (LIDAR) sensor and an assembly of one or more cameras.

6. The method of claim 5, wherein the list further consists of a simulator module, configured to produce a simulated, three-dimensional environment, and wherein the one or more second data elements pertain to the simulated, three-dimensional environment.

7. The method of claim 6, further comprising constructing a radar image that is characterized by the third performance parameter value, based on the one or more third data elements.

8. A method of enhancing an EM sensor signal, the method comprising:
receiving one or more data elements pertaining to a first signal of the EM sensor, the signal characterized by a first performance parameter value;
inputting the one or more data elements to a neural network (NN) model; and
generating a second signal from at least one output of the NN model,
wherein the second signal is characterized by a second performance parameter value, and wherein the second performance parameter value is higher than the first performance parameter value.

9. The method of claim 8, wherein the performance parameter is selected from a list consisting of: a spatial resolution, a Doppler resolution, a temporal resolution, a frequency resolution, an angular resolution and an SNR.

10. The method of claim 9, wherein the EM sensor is a radar, and wherein the second signal is a radar image, selected from a list consisting of: a point cloud, a depth map and a range-Doppler map.

11. A system for enhancing a signal of an EM sensor, the system comprising a NN model, associated with the EM sensor and configured to receive one or more first data elements from the EM sensor, and produce therefrom one or more second data elements, wherein the one or more first data elements are characterized by a first performance parameter value and wherein the one or more second data elements are characterized by a second, higher performance parameter value.

12. The system of claim 11 wherein the performance parameter is selected from a list consisting of: a spatial resolution, a temporal resolution, a frequency resolution, a Doppler resolution an angular resolution and an SNR.

13. The system of claim 12 further comprising:
a non-transitory memory device, wherein modules of instruction code are stored; and
a processor associated with the memory device, and configured to execute the modules of instruction code,
whereupon execution of said modules of instruction code, the processor is configured to generate an image from the one or more second data elements, wherein the image is characterized by the second performance parameter value.

14. The system of claim 13 wherein the EM sensor is a radar, and wherein the radar is selected from a list consisting of a point cloud and a depth map.

15. A system for training one or more ML models to enhance a performance of an EM sensor, the system comprising: a non-transitory memory device, wherein modules of instruction code are stored, and a processor associated with the memory device, and configured to execute the modules of instruction code, whereupon execution of said modules of instruction code, the processor is further configured to perform at least one of:
receive one or more first data elements pertaining to a first signal of the EM sensor having a first performance parameter value;
receive one or more second data elements pertaining to a second signal of a data generator, having a second performance parameter value; and
train at least one ML model to generate a third signal, using the one or more first data elements as a training data set and using the one or more second data elements as supervisory annotated data,
wherein the third signal is characterized by a third performance parameter value that is higher than the first performance parameter value.

16. The system of claim 15 further comprising at least one digital signal processing module, having one or more processing modules and wherein training at least one ML model to generate the third signal comprises using one or more output data elements of one or more processing modules as a training data set.

17. The system of claim 16, wherein the one or more ML models are arranged in a cascade, and wherein training at least one ML model to generate the third signal comprises using an output of a preceding ML model as supervisory annotated data.

18. The system of claim 15 wherein the performance parameter is selected from a list consisting of: a spatial resolution, a temporal resolution, a frequency resolution, a Doppler resolution an angular resolution and an SNR.

19. The system of claim 15, wherein the processor is further configured to:
synchronize between a first timing of the reception of the one or more first data elements and a second timing of the reception of the one or more second data elements;
perform spatial registration between the one or more first data elements and the one or more second data elements; and
using the one or more second data elements to self-supervise training of the ML model.

20. A method for training an ML model to enhance a performance of an EM sensor, the method comprising:
receiving one or more first data elements pertaining to a first signal of an EM sensor having a first performance parameter value;
generating one or more second data elements from the one or more first data elements having a second performance parameter value that is lower than the first performance parameter value; and
training the ML model to generate a third signal, using the one or more second data elements as a training data set and using the one or more first data elements serve as supervisory data,
wherein the third signal is characterized by a third performance parameter value that is higher than the second performance parameter value.
